(19) United States
(12) Patent Application Publication
(10) Pub. No.: US 2013/0262780 A1
(43) Pub. Date: Oct. 3, 2013

(54) Apparatus and Method for Fast Cache Shutdown

(71) Applicants: Srilatha Manne, Portland, OR (US); William L. Bircher, Austin, TX (US); Madhu Sarvana Sibi Govindan, Austin, TX (US); James M. O'Connor, Austin, TX (US); Michael J. Schulte, Austin, TX (US)

(72) Inventors: Srilatha Manne, Portland, OR (US); William L. Bircher, Austin, TX (US); Madhu Sarvana Sibi Govindan, Austin, TX (US); James M. O'Connor, Austin, TX (US); Michael J. Schulte, Austin, TX (US)

(21) Appl. No.: 13/435,539

(22) Filed: Mar. 30, 2012

(51) Int. Cl. G06F 12/08

(52) U.S. Cl. 711/142; 711/141; 711/E12.04; 711/E12.017

(57) ABSTRACT

An apparatus and method to enable a fast cache shutdown is disclosed. In one embodiment, a cache subsystem includes a cache memory and a cache controller coupled to the cache memory. The cache controller is configured to, upon restoring power to the cache subsystem, inhibit writing of modified data exclusively into the cache memory.

### BACKGROUND

1. Technical Field

This disclosure relates to integrated circuits, and more particularly, to cache subsystems in processors.

2. Description of the Related Art

As integrated circuit technology has advanced, the feature size of transistors has continued to shrink. This has enabled more circuitry to be implemented on a single integrated circuit die. This in turn has allowed for the implementation of more functionality on integrated circuits. Processors having multiple cores are one example of the increased amount of functionality that can be implemented on an integrated circuit.

During the operation of processors having multiple cores, there may be instances when at least one of the cores is inactive. In such instances, an inactive processor core may be powered down in order to reduce overall power consumption. Powering down an idle processor core may include powering down various subsystems implemented therein, including a cache. In some cases, a cache may be storing modified data at the time it is determined that the processor core is to be powered down. If the modified data is unique to the cache in the processor core, the data may be written to a lower level cache (e.g. from a level 1, or L1 cache, to a level 2, or L2 cache), or may be written back to memory. After the modified data has been written to a lower level cache or back to memory, the cache may be ready for powering down if other portions of the processor core are also ready for powering down.

### SUMMARY OF THE DISCLOSURE

An apparatus and method to enable a fast cache shutdown is disclosed. In one embodiment, a cache subsystem includes a cache memory and a cache controller coupled to the cache memory. The cache controller is configured to, upon restoring power to the cache subsystem, inhibit writing of modified data exclusively into the cache memory.

In one embodiment, a method includes restoring power to a cache subsystem including a cache memory. The method further includes inhibiting modified data from being written exclusively into the cache memory.

### BRIEF DESCRIPTION OF THE DRAWINGS

Other aspects of the disclosure will become apparent upon reading the following detailed description and upon reference to the accompanying drawings briefly described below.

FIG. 1 is a block diagram of one embodiment of a computer system.

FIG. 2 is a block diagram of one embodiment of a processor having multiple cores and a shared cache.

FIG. 3 is a block diagram of one embodiment of a cache subsystem.

FIG. 4 is a flow diagram of one embodiment of a method for operating a cache subsystem in which modified data is excluded from the cache upon restoring power and prior to a threshold value being reached.

FIG. 5 is a flow diagram of one embodiment of a method for operating a cache subsystem in a write bypass mode.

FIG. 6 is a block diagram of one embodiment of a cache subsystem illustrating operation in a write bypass mode.

FIG. 7 is a flow diagram of one embodiment of a method for operating a cache subsystem illustrating operation in a write-through mode.

FIG. 8 is a block diagram of one embodiment of a cache subsystem illustrating operation in a write-through mode.

FIG. 9 is a block diagram illustrating one embodiment of a computer readable medium including a data structure describing an embodiment of a cache subsystem.

While the invention is susceptible to various modifications and alternative forms, specific embodiments thereof are shown by way of example in the drawings and will herein be described in detail. It should be understood, however, that the drawings and description thereto are not intended to limit the invention to the particular form disclosed, but, on the contrary, the invention is to cover all modifications, equivalents, and alternatives falling within the spirit and scope of the present invention as defined by the appended claims.

### DETAILED DESCRIPTION

The present disclosure is directed to a method and apparatus for inhibiting a cache memory from storing modified data exclusive of other locations in a memory hierarchy for a limited time upon restoring power. The limited time may be defined by a threshold value. In a prior art cache subsystem, powering down the cache to put it in a sleep state (e.g., when a corresponding processor core is idle) may include a cache controller examining the storage locations of a corresponding cache for modified data. If modified data is found in one or more of the storage locations, it may be written to another cache that is lower in the memory hierarchy (e.g., from an L1 cache to an L2 cache), or to main memory. In contrast, a cache subsystem of the present disclosure may be powered down without examining the cache memory for modified data if the threshold value has not yet been reached. Since the cache memory is inhibited from storing modified data exclusively of other caches and memory a in the memory hierarchy prior to the threshold being reached, it is not necessary to check the cache prior to powering down. Accordingly, a processor core or other functional unit that includes such a cache subsystem may be powered down to save power when that functional unit is idle, without the inherent delay incurred by determining whether modified data is present. In general, a cache subsystem as described herein, when implemented in a processor core (or other functional unit) may enable an exit from a sleep state to perform tasks short in duration and to be quickly placed back into the sleep state without the delay incurred by searching for modified data and writing it back to memory or another cache.

A threshold value may be implemented in various ways. In one embodiment, a threshold value may be a predetermined amount of time from the time at which power was restored to the cache subsystem. Prior to the elapsing of the predetermined amount of time, the cache controller may inhibit writes of modified data exclusively into its corresponding cache. If the cache subsystem (and/or a unit in which it is implemented) becomes idle before the predetermined amount of time has elapsed, it may be powered down again without having to search the cache for modified data and write any modified data found to another cache or main memory. If the cache subsystem is not idle before the predetermined amount of time has elapsed, the cache controller may then enable modified data to be written exclusively to its corresponding cache.

In another embodiment, the threshold may be defined by the occurrence of a particular number of events. The events may be cache evictions, instances of modified data produced by an execution unit, the amount of traffic to and/or from the cache, and so on. In general, the events may be any type that may be indicative of a level of processing activity occurring in the circuitry associated with the cache subsystem. In embodiments in which the threshold is event-based, the time at which the threshold value is reached may vary from one instance of powering on the cache subsystem to the next.

The handling of modified data during the period between the powering on of the cache subsystem and the reaching of the threshold value may be accomplished in different ways. In one embodiment, the cache subsystem may operate in a write-through mode. When operating in the write through mode, modified data may be written to both the cache as well as to another storage location that is lower in the memory hierarchy (e.g., a lower cache, or into main memory). Thus, modified data is stored in a location lower in the memory hierarchy in addition to the cache. As such, it is not necessary to copy and write back the modified data from the cache before removing power therefrom, since it is already stored in at least one storage location that is lower in the memory hierarchy. The cache subsystem may discontinue operation in the write-through mode when the threshold value is reached, or when power is removed therefrom. Operation in the write-through mode may be resumed when power is restored to the cache from a sleep (or other un-powered) state.

In another embodiment, the cache subsystem may operate in a write-bypass mode. When operating in the write bypass mode, the cache controller may inhibit any modified data from being written into the cache. Instead, modified data that is generated during operation in the write bypass mode is instead written to at least one lower level storage location in the memory hierarchy. For example, is a cache subsystem for an L1 data cache is operating in the write-bypass mode, modified data generated by an execution unit may be written to an L2 cache, an L3 cache, and/or main memory. The cache subsystem may discontinue operation in the write-bypass mode responsive to reaching the threshold value or when power is removed therefrom. Resumption of operation in the write-bypass mode may occur when power is restored to the cache subsystem.

It is also noted that embodiments are possible and contemplated in which modified data may be stored in another cache at the same level in the memory hierarchy, but in a different power domain.

It is noted that in some embodiments, multiple caches and their corresponding subsystems may be operated in one of the modes described above. For example, in a processor core having and L1 cache and an L2 cache, the corresponding cache subsystems may both operate in one of the write-through or write-bypass modes. Thus, if two different caches are coupled to the same power distribution circuitry, the benefits of rapid shutdown may still be obtained.

Furthermore, in embodiments in which multiple levels of cache memory may operate in the modes described above, it is not necessary that both cache subsystems operate in the same mode. For example, the L1 cache may operate in the write-bypass mode while the L2 cache may operate in the write-through mode.

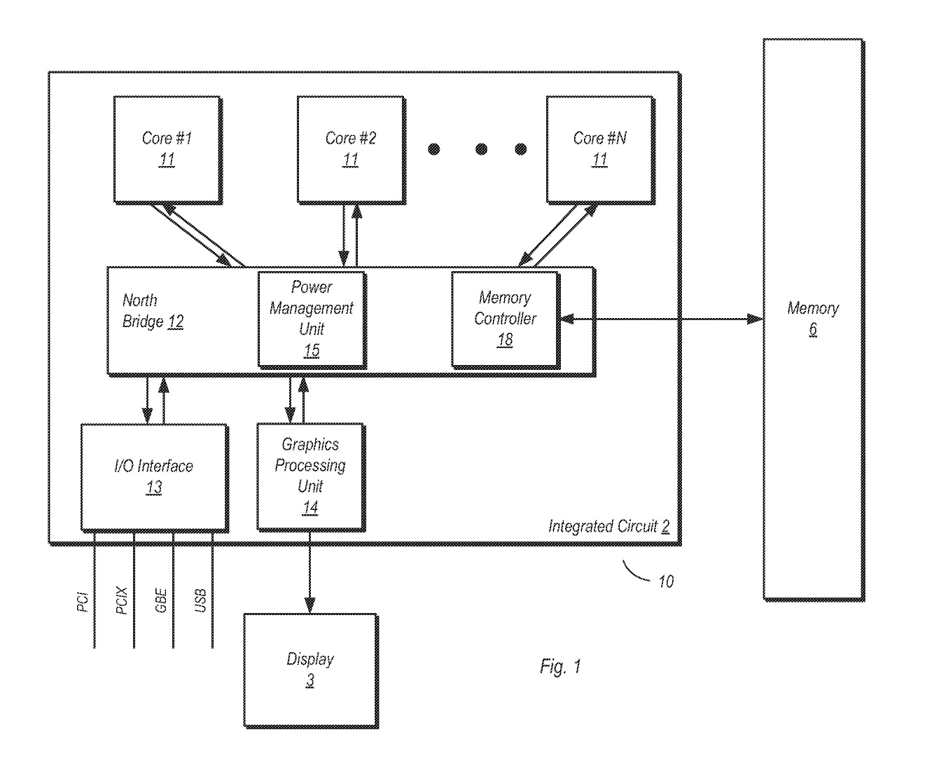

FIG. 1 is a block diagram of one embodiment of a computer system 10. In the embodiment shown, computer system 10 includes integrated circuit (IC) 2 coupled to a memory 6. In the embodiment shown, IC 2 is a system on a chip (SOC) having a number of processor cores 11, which are processor cores in this embodiment. In various embodiments, the number of processor cores may be as few as one, or may be as many as feasible for implementation on an IC die. In multi-core embodiments, processor cores 11 may be identical to each other (i.e. symmetrical multi-core), or one or more cores may be different from others (i.e. asymmetric multi-core). Processor cores 11 may each include one or more execution units, cache memories, schedulers, branch prediction circuits, and so forth. Furthermore, each of processor cores 11 may be configured to assert requests for access to memory 6, which may function as the main memory for computer system 10. Such requests may include read requests and/or write requests, and may be initially received from a respective processor core 11 by north bridge 12. Requests for access to memory 6 may be initiated responsive to the execution of certain instructions, and may also be initiated responsive to prefetch operations.

I/O interface 13 is also coupled to north bridge 12 in the embodiment shown. I/O interface 13 may function as a south bridge device in computer system 10. A number of different types of peripheral buses may be coupled to I/O interface 13. In this particular example, the bus types include a peripheral component interconnect (PCI) bus, a PCI-Extended (PCI-X), a PCIE (PCI Express) bus, a gigabit Ethernet (GBE) bus, and a universal serial bus (USB). However, these bus types are exemplary, and many other bus types may also be coupled to I/O interface 13. Various types of peripheral devices (not shown here) may be coupled to some or all of the peripheral buses. Such peripheral devices include (but are not limited to) keyboards, mice, printers, scanners, joysticks or other types of game controllers, media recording devices, external storage devices, network interface cards, and so forth. At least some of the peripheral devices that may be coupled to I/O unit 13 via a corresponding peripheral bus may assert memory access requests using direct memory access (DMA). These requests (which may include read and write requests) may be conveyed to north bridge 12 via I/O interface 13.

In the embodiment shown, IC 2 includes a graphics processing unit 14 that is coupled to display 3 of computer system 10. Display 3 may be a flat-panel LCD (liquid crystal display), plasma display, a CRT (cathode ray tube), or any other suitable display type. GPU 14 may perform various video processing functions and provide the processed information to display 3 for output as visual information.

Memory controller 18 in the embodiment shown is integrated into north bridge 12, although it may be separate from north bridge 12 in other embodiments. Memory controller 18 may receive memory requests conveyed from north bridge 12. Data accessed from memory 6 responsive to a read request (including prefetches) may be conveyed by memory controller 18 to the requesting agent via north bridge 12. Responsive to a write request, memory controller 18 may receive both the request and the data to be written from the requesting agent via north bridge 12. If multiple memory access requests are pending at a given time, memory controller 18 may arbitrate between these requests.

Memory 6 in the embodiment shown may be implemented in one embodiment as a plurality of memory modules. Each of the memory modules may include one or more memory devices (e.g., memory chips) mounted thereon. In another embodiment, memory 6 may include one or more memory devices mounted on a motherboard or other carrier upon which IC 2 may also be mounted. In yet another embodiment, at least a portion of memory 6 may be implemented on the die of IC 2 itself. Embodiments having a combination of the various implementations described above are also possible and contemplated. Memory 6 may be used to implement a random access memory (RAM) for use with IC 2 during operation. The RAM implemented may be static RAM (SRAM) or dynamic RAM (DRAM). Type of DRAM that may be used to implement memory 6 include (but are not limited to) double data rate (DDR) DRAM, DDR2 DRAM, DDR3 DRAM, and so forth.

Although not explicitly shown in FIG. 1, IC 2 may also include one or more cache memories that are external to the processor cores 11. As will be discussed below, each of the processor cores 11 may include an L1 data cache and an L1 instruction cache. In some embodiments, each processor core 11 may be associated with a corresponding L2 cache. Each L2 cache may be internal or external to its corresponding processor core. An L3 cache that is shared among the processor cores 11 may also be included in one embodiment of IC 2. In general, various embodiments of IC 2 may implement a number of different levels of cache memory, with some of the cache memories being shared between the processor cores while other cache memories may be dedicated to a specific one of processor cores 11.

North bridge 12 in the embodiment shown also includes a power management unit 15, which may be used to monitor and control power consumption among the various functional units of IC 2. More particularly, power management unit 15 may monitor activity levels of each of the other functional units of IC 2, and may perform power management actions is a given functional unit is determined to be idle (e.g., no activity for a certain amount of time). In addition, power management unit 15 may also perform power management actions in the case that an idle functional unit needs to be activated to perform a task. Power management actions may include removing power, gating a clock signal, restoring power, restoring the clock signal, reducing or increasing and operating voltage, and reducing and increasing a frequency of a clock signal. In some cases, power management unit 15 may also re-allocate workloads among the processor cores 11 such that each may remain within thermal design power limits. In general, power management unit 15 may perform any function related to the control and distribution of power to the other functional units of IC 2.

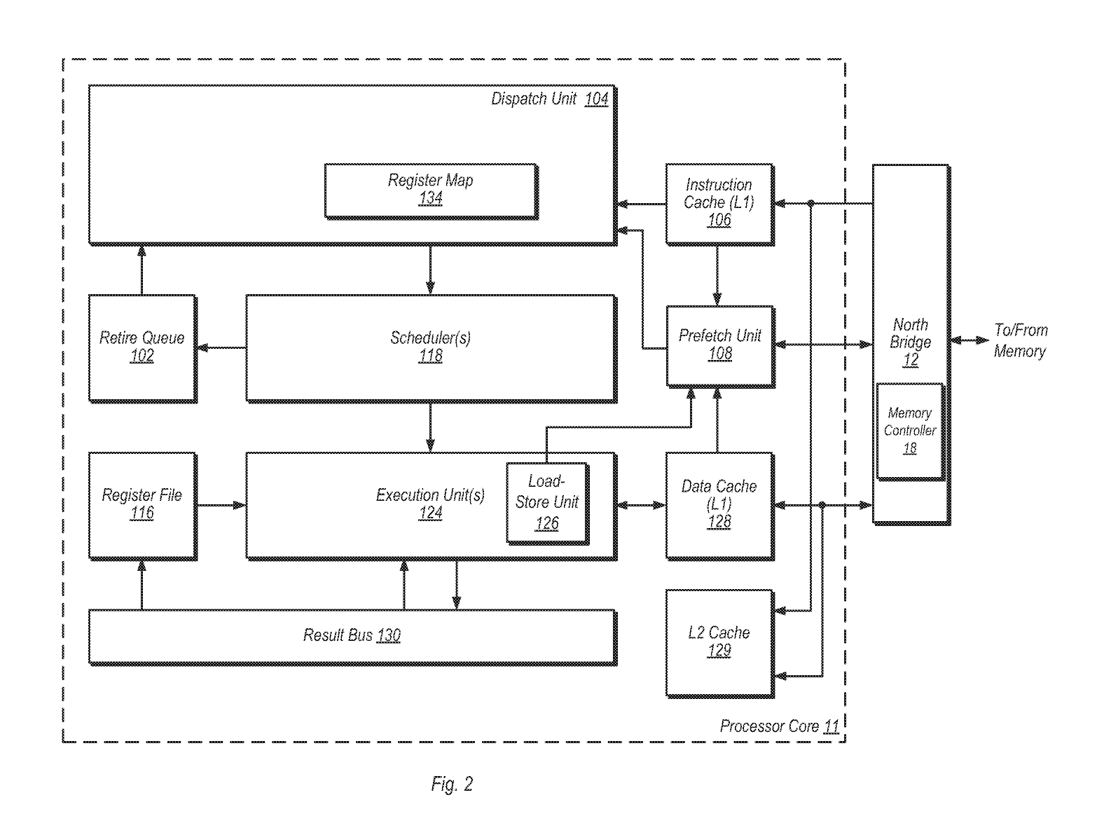

FIG. 2 is a block diagram of one embodiment of a processor core 11. The processor core 11 is configured to execute instructions stored in a system memory (e.g., memory 6 of FIG. 1). Many of these instructions may also operate on data stored in memory 6. It is noted that the memory 6 may be physically distributed throughout a computer system and/or may be accessed by one or more processing nodes 11.

In the illustrated embodiment, the processor core 11 may include an L1 instruction cache 106 and an L1 data cache 128. The processor core 11 may include a prefetch unit 108 coupled to the instruction cache 106, which will be discussed in additional detail below. A dispatch unit 104 may be configured to receive instructions from the instruction cache 106 and to dispatch operations to the scheduler(s) 118. One or more of the schedulers 118 may be coupled to receive dispatched operations from the dispatch unit 104 and to issue operations to the one or more execution unit(s) 124. The execution unit(s) 124 may include one or more integer units, one or more floating point units. At least one load-store unit 126 is also included among the execution units 124 in the embodiment shown. Results generated by the execution unit(s) 124 may be output to one or more result buses 130 (a single result bus is shown here for clarity, although multiple result buses are possible and contemplated). These results may be used as operand values for subsequently issued instructions and/or stored to the register file 116. A retire queue 102 may be coupled to the scheduler(s) 118 and the dispatch unit 104. The retire queue 102 may be configured to determine when each issued operation may be retired.

In one embodiment, the processor core 11 may be designed to be compatible with the x86 architecture (also known as the Intel Architecture-32, or IA-32). In another embodiment, the processor core 11 may be compatible with a 64-bit architecture. Embodiments of processor core 11 compatible with other architectures are contemplated as well.

Note that the processor core 11 may also include many other components. For example, the processor core 11 may include a branch prediction unit (not shown) configured to predict branches in executing instruction threads. In some embodiments (e.g., if implemented as a stand-alone processor), processor core 11 may also include a memory controller configured to control reads and writes with respect to memory 6.

The instruction cache 106 may store instructions for fetch by the dispatch unit 104. Instruction code may be provided to the instruction cache 106 for storage by prefetching code from the system memory 200 through the prefetch unit 108. Instruction cache 106 may be implemented in various configurations (e.g., set-associative, fully-associative, or direct-mapped).

Processor core 11 may also be associated with an L2 cache 129. In the embodiment shown, L2 cache 129 is internal to and included in the same power domain as processor core 11. Embodiments wherein L2 cache 129 is external to and separate from the power domain as processor core 11 are also possible and contemplated. Whereas instruction cache 106 may be used to store instructions and data cache 128 may be used to store data (e.g., operands), L2 cache 129 may be a unified cache used to store instructions and data. However, embodiments are also possible and contemplated wherein separate L2 caches are implemented for instructions and data.

The dispatch unit 104 may output operations executable by the execution unit(s) 124 as well as operand address information, immediate data and/or displacement data. In some embodiments, the dispatch unit 104 may include decoding circuitry (not shown) for decoding certain instructions into operations executable within the execution unit(s) 124. Simple instructions may correspond to a single operation. In some embodiments, more complex instructions may correspond to multiple operations. Upon decode of an operation that involves the update of a register, a register location within register file 116 may be reserved to store speculative register states (in an alternative embodiment, a reorder buffer may be used to store one or more speculative register states for each register and the register file 116 may store a committed register state for each register). A register map 134 may translate logical register names of source and destination operands to physical register numbers in order to facilitate register renaming. The register map 134 may track which registers within the register file 116 are currently allocated and unallocated.

The processor core 11 of FIG. 2 may support out of order execution. The retire queue 102 may keep track of the original program sequence for register read and write operations, allow for speculative instruction execution and branch misprediction recovery, and facilitate precise exceptions. In some embodiments, the retire queue 102 may also support register renaming by providing data value storage for speculative register states (e.g. similar to a reorder buffer). In other embodiments, the retire queue 102 may function similarly to a reorder buffer but may not provide any data value storage. As operations are retired, the retire queue 102 may deallocate registers in the register file 116 that are no longer needed to store speculative register states and provide signals to the register map 134 indicating which registers are currently free. By maintaining speculative register states within the register file 116 (or, in alternative embodiments, within a reorder buffer) until the operations that generated those states are validated, the results of speculatively-executed operations along a mispredicted path may be invalidated in the register file 116 if a branch prediction is incorrect.

In one embodiment, a given register of register file 116 may be configured to store a data result of an executed instruction and may also store one or more flag bits that may be updated by the executed instruction. Flag bits may convey various types of information that may be important in executing subsequent instructions (e.g. indicating a carry or overflow situation exists as a result of an addition or multiplication operation. Architecturally, a flags register may be defined that stores the flags. Thus, a write to the given register may update both a logical register and the flags register. It should be noted that not all instructions may update the one or more flags.

The register map 134 may assign a physical register to a particular logical register (e.g. architected register or microarchitecturally specified registers) specified as a destination operand for an operation. The dispatch unit 104 may determine that the register file 116 has a previously allocated physical register assigned to a logical register specified as a source operand in a given operation. The register map 134 may provide a tag for the physical register most recently assigned to that logical register. This tag may be used to access the operand's data value in the register file 116 or to receive the data value via result forwarding on the result bus 130. If the operand corresponds to a memory location, the operand value may be provided on the result bus (for result forwarding and/or storage in the register file 116) through load-store unit 126. Operand data values may be provided to the execution unit(s) 124 when the operation is issued by one of the scheduler(s) 118. Note that in alternative embodiments, operand values may be provided to a corresponding scheduler 118 when an operation is dispatched (instead of being provided to a corresponding execution unit 124 when the operation is issued).

As used herein, a scheduler is a device that detects when operations are ready for execution and issues ready operations to one or more execution units. For example, a reservation station may be one type of scheduler. Independent reservation stations per execution unit may be provided, or a central reservation station from which operations are issued may be provided. In other embodiments, a central scheduler which retains the operations until retirement may be used. Each scheduler 118 may be capable of holding operation information (e.g., the operation as well as operand values, operand tags, and/or immediate data) for several pending operations awaiting issue to an execution unit 124. In some embodiments, each scheduler 118 may not provide operand value storage. Instead, each scheduler may monitor issued operations and results available in the register file 116 in order to determine when operand values will be available to be read by the execution unit(s) 124 (from the register file 116 or the result bus 130).

The prefetch unit 108 may prefetch instruction code from the memory 6 for storage within the instruction cache 106. In the embodiment shown, prefetch unit 108 is a hybrid prefetch unit that may employ two or more different ones of a variety of specific code prefetching techniques and algorithms. The prefetching algorithms implemented by prefetch unit 108 may be used to generate address from which data may be prefetched and loaded into registers and/or a cache. Prefetch unit 108 may be configured to perform arbitration in order to select which of the generated addresses is to be used for performing a given instance of the prefetching operation.

As noted above, processor core 11 includes L1 data and instruction caches and is associated with at least one L2 cache. In some cases, separate L2 caches may be provided for data and instructions, respectively. The L1 data and instruction caches may be part of a memory hierarchy, and may be below the architected registers of processor core 11 in that hierarchy. The L2 cache(s) may be below the L1 data and instruction caches in the memory hierarchy. Although not explicitly shown, an L3 cache may also be present (and may be shared among multiple processor cores 11), with the L3 cache being below any and all L2 caches in the memory hierarchy. Below the various levels of cache memory in the memory hierarchy may be main memory, with disk storage (or flash storage) being below the main memory.

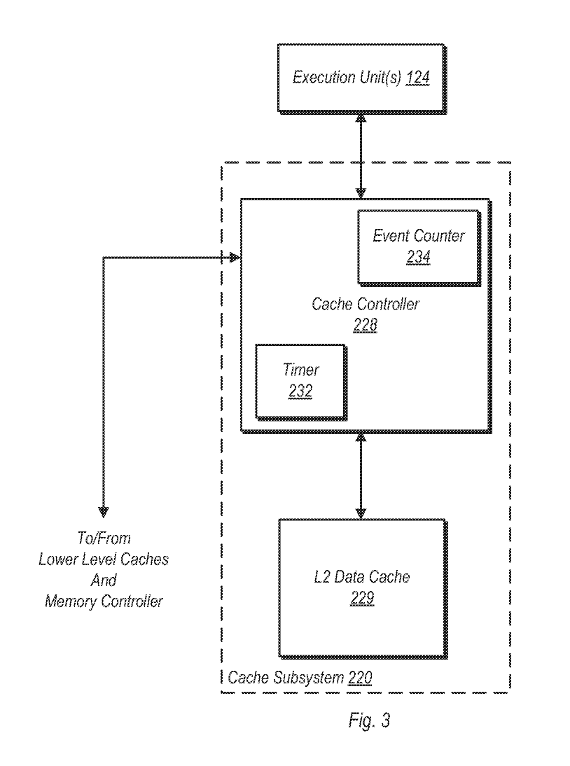

FIG. 3 is a block diagram illustrating one embodiment of an exemplary cache subsystem. In this particular example, cache subsystem is directed to an L2 data cache of a processor core. However, the general arrangement as shown here may apply to any cache subsystem in which modified data may be stored in the corresponding cache.

In the embodiment shown, cache subsystem 220 includes L2 data cache 229 and a cache controller 228. 21 data cache is a cache that may be used for storing data (e.g., operands) and may be implemented in various configurations (e.g., set-associative, fully-associative, or direct-mapped).

Cache control 228 is configured to control access to L2 data cache 229 for both read and write operations. In the particular implementation shown in FIG. 3, cache controller 228 may read and provide data from L2 data cache 229 to execution unit(s) 124 (or to registers to be accessed by the execution units for execution of a particular instruction). In addition, cache controller 228 may also perform evictions of cache lines when the data stored therein is old or is to be removed to add new data. Cache controller 228 may also communicate with other cache subsystems (e.g., to a cache controller for an L1 cache) as well as a memory controller in order to cause data to be written to a storage location at a lower level in the memory hierarchy.

Another function provided by cache control unit 228 in the embodiment shown is controlling when modified data can be written to and exclusively stored in L2 data cache 229. Cache controller 228 may receive data resulting from instructions executed by execution unit(s) 124, and may exert control over the writing of that data to L2 data cache 229. In this embodiment, cache controller 228 may inhibit modified data from being written exclusively into L2 data cache 229 for a certain amount of time upon restoring power to cache subsystem 220. That is, for a certain time period, cache controller 228 may either prevent modified data from being written to L2 data cache 229 unless it is written to another location further down in the memory hierarchy, or may prevent modified data from being written into L2 data cache 229 altogether.

The amount of time that cache controller inhibits the exclusive writing to and storing of modified data in L2 data cache 229 may be determined based on a threshold value. The threshold value may be time-based or event-based. In the embodiment shown, cache controller 228 includes a timer 232 configured to track and amount of time since the restoration of power to cache subsystem 220 relative to a predetermined time threshold value. Cache controller 228 in the illustrated embodiment also includes an event counter 234 configured to count and track the occurrence of a certain number of pre-defined events (e.g., instances of modified data being generated by an execution unit, instructions executed, memory accesses, etc.). The number of events counted may be compared to a corresponding threshold value. It is noted that in various embodiments, cache controller 228 may include only one of the timer 232 or event counter 234. In general, any suitable mechanism for implementing a threshold value may be included in a given embodiment of cache controller 228.

If a threshold value is reached or exceeded subsequent to restoring power to cache subsystem 220, cache controller 228 may discontinue inhibiting L1 data cache from storing modified data exclusive of other locations lower in the memory hierarchy. Any issuance of modified data by an execution unit (or other source) subsequent to the reaching of the threshold value may result in the modified data being written into L2 data cache 229 without requiring any further writeback prior to its eviction.

In some instances, the threshold value may not be reached before cache subsystem 220 or its corresponding functional unit (e.g., a processor core 11 as described above). In such a case, cache subsystem 220 (and its corresponding functional unit) may be placed in a sleep state by removing power therefrom. Since the threshold value has not been reached in this case, it follows that L2 data cache 229 is not storing modified data. Accordingly, since no modified data is stored in L2 data cache 229, there is no need to search the cache for modified data or to write back any modified data found to a location lower in the memory hierarchy. This may significantly reduce the amount of time taken to enter a sleep state once the determination is made to power down the cache. As a result power consumption may be reduced. Furthermore, the ability to quickly enter and exit a sleep state may allow for a cache subsystem (and corresponding functional unit) to be powered up for performed short-lived tasks and then to be quickly powered back down into the sleep state.

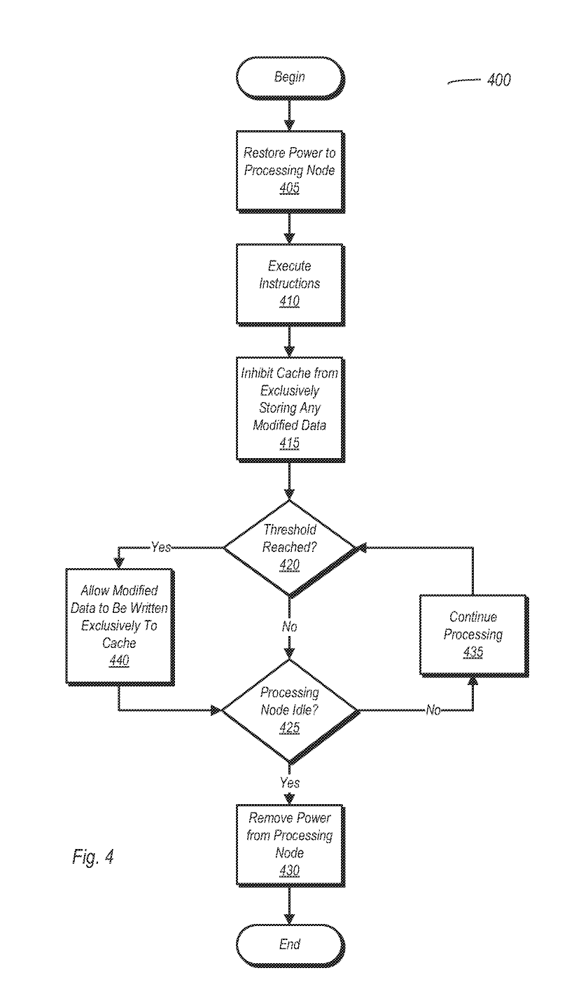

FIG. 4 is a flow diagram of one embodiment of a method for operating a cache subsystem in which modified data is excluded from the cache upon restoring power and prior to a threshold value being reached. The embodiment of method 400 described herein is directed to a cache subsystem implemented in a processor core or other type of processing node (e.g., as described above). However, similar methodology may be applied to any cache subsystem, regardless of whether it is implemented as part of or separate from other functional units.

Method 400 begins with the restoring of power to a processing node that includes a cache subsystem (block 405). Upon restoring power to the processing node, the execution of instructions may begin (block 410). The execution of instructions may be performed by execution units or other appropriate circuitry. In some instances, the execution of instructions may modify data that was previously provided from memory to the cache. However, for a time prior to reaching a threshold value, a cache controller may inhibit the cache from storing modified data exclusive of other storage locations in the memory hierarchy (block 415). In one embodiment, this may be accomplished by causing modified data to be written to at least one other location lower in the memory hierarchy in addition to being written to the cache. In another embodiment, this may be accomplished by inhibiting the writing of any modified data into the cache, and instead forcing it to be written to a storage location at a lower level in the memory hierarchy. Inhibiting the cache from storing modified data exclusive of other, lower level locations in the memory hierarchy may continue as long as a threshold value has not been reached.

If the threshold value has not been reached, (block 420, no), but the processing node is not idle (block 425, no), then processing may continue (block 425). If the threshold value has not been reached (block 420, no) and the processing node is idle (block 425, yes), then the processing node may be placed into a sleep mode by removing power therefrom (block 430). Since the threshold value was not reached prior to removing power, there is no need to search the cache for modified data stored exclusively therein or to write it back to memory or to a lower level cache in the memory hierarchy. Thus, entry into the sleep mode may be accomplished faster than would otherwise be possible if modified data was stored exclusively in the cache memory.

If the threshold value is reached prior to the processing node becoming idle (block 420, yes), then the cache controller may allow modified data to be stored exclusively in the cache memory. If the processing node is not idle (block 425), processing may continue, with the cache controller allowing exclusive writes of modified data to the cache. It is noted that once the threshold is reached, block 420 may remain on the ‘yes’ path until the processing node becomes idle. Once the processing node becomes idle (block 425, yes), power may be removed from the processing node to put it into a sleep state. However, since the threshold was reached prior to the processing node becoming idle, the cache memory may be searched for modified data prior to entry into the sleep mode. Any modified data found in the cache may then be written back to memory or to a lower level cache memory.

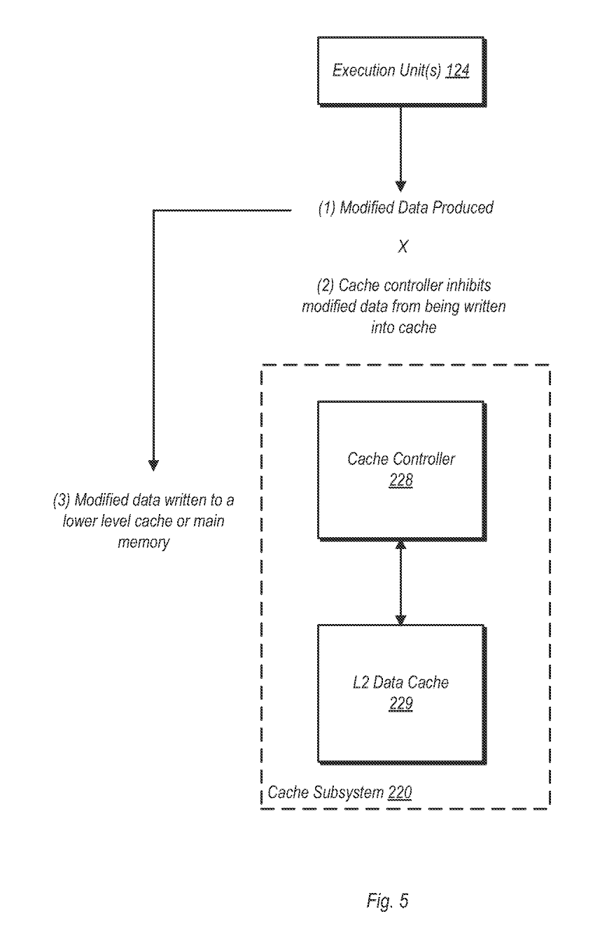

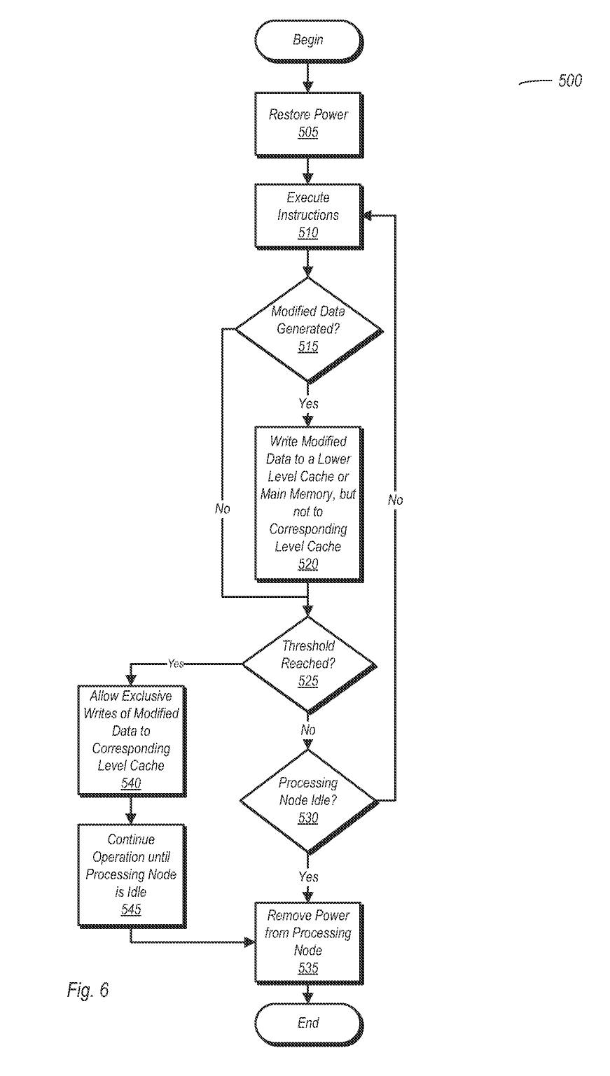

FIGS. 5 and 6 illustrate operation of a cache subsystem in a mode referred to as the write-bypass mode. Operation is described in reference to the embodiment of cache subsystem 220 previously described in FIG. 3, although it is noted that the methodology described herein may be performed with other embodiments of a cache subsystem.

As shown in FIG. 5, when operating in the write bypass mode cache controller 228 may inhibit any writes of modified data into L1 data cache 228. Modified data may be produced by execution unit(s) 124 during the execution of certain instructions (1). Cache controller 228 may prevent the modified data from being written into L2 data cache 229 (2). The modified data is instead written to at least one of a lower level cache memory or main memory (3). Accordingly, L2 data cache 229 does not receive or store any modified data when operating in the write bypass mode.

FIG. 6 further illustrates operation in the write-bypass mode. Method 500 begins with the restoring of power (e.g., exiting a sleep state) to a cache subsystem (block 505). The method further includes the execution of instructions that may in some cases generate modified data (block 510). If modified data is generated responsive to the execution of an instruction (block 515, yes), then the cache controller may inhibit the modified data from being written to its corresponding cache, and may instead cause it to be written to a lower level cache or main memory (block 520). If an instruction does not generate modified data (block 515, no), then the method may proceed to block 525.

If the threshold has not been reached (block 525, no), and the processing node associated with the cache subsystem is not idle (block 530, no), the method returns to block 510. If the threshold has not been reached (block 525, no), but the processing node has become idle (block 530, yes), then the cache subsystem (and the corresponding processing node) may be placed into a sleep state by removing power (block 535). Since the threshold has not been reached in this example, it is not necessary to search the cache for modified data since the writing of the same to the cache has been inhibited.

If the threshold is reached (block 525, yes), then processing may continue while allowing writes of modified data to the cache (block 540). The modified data may be written to and stored exclusively in the cache. The cache may maintain exclusive storage of the modified data until it is to be evicted for new data or until the cache subsystem is to be powered down. Once either of these two events occurs, the modified data may be written to a lower level cache or to main memory. At block 545, the processing node may continue operation until idle, at which time power may be removed therefrom (block 535).

For embodiments in which the L2 cache is a shared cache (i.e. storing both data and instructions), a variation of the write bypass mode may be implemented. In such an embodiment, prior to the threshold being reached, the L2 cache may be operated exclusively as an instruction cache. Therefore, if the threshold has not been reached, no data is written to the L2 cache. As such, if the threshold is not reached by the time the corresponding cache subsystem becomes idle, it may be placed in a sleep state without searching the L2 for modified data, since no data has been written thereto. On the other hand, if the threshold is reached before the cache subsystem becomes idle, writes of data to the L2 cache (both modified and unmodified) may be permitted thereafter.

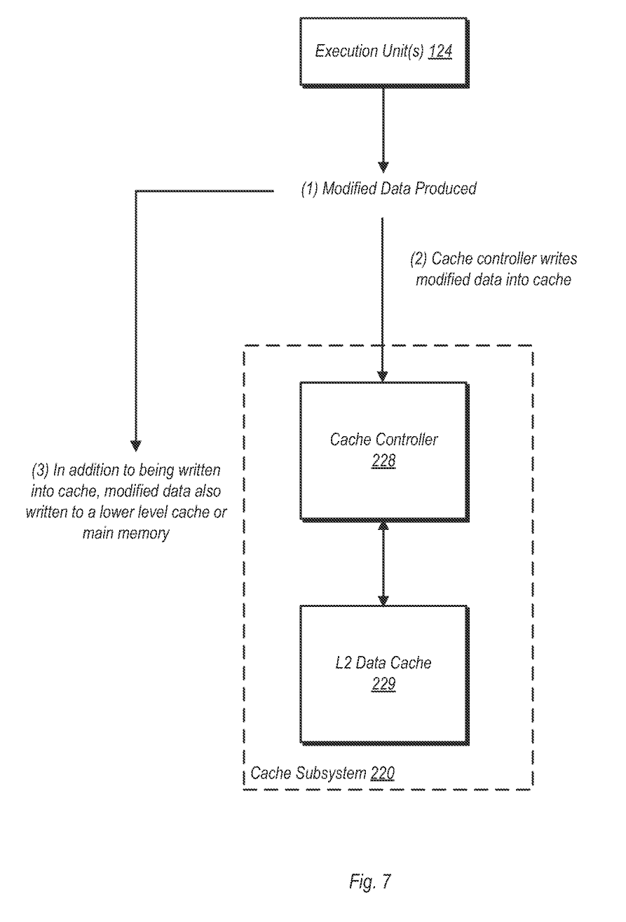

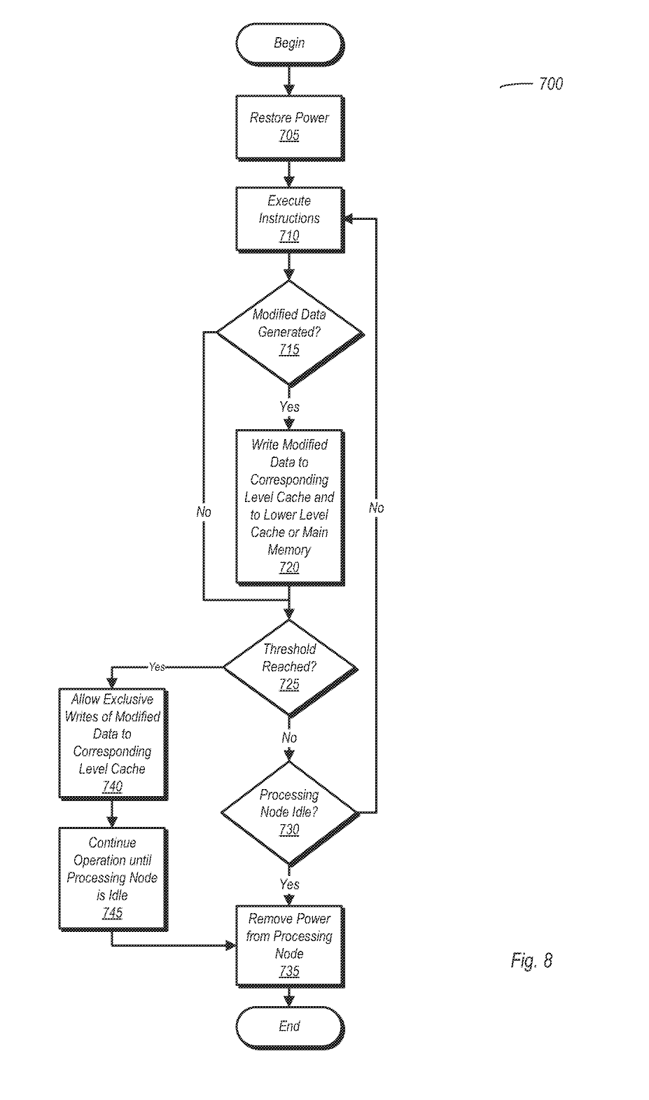

FIGS. 7 and 8 illustrate operation of a cache subsystem in a mode referred to as the write-through mode. Operation is described in reference to the embodiment of cache subsystem 220 previously described in FIG. 3, although it is noted that the methodology described herein may be performed with other embodiments of a cache subsystem.

As shown in FIG. 7, writes of modified data to the L1 data cache during operation in the write-through mode may be accompanied with an additional write of the modified data to a storage location farther down in the memory hierarchy. Modified data may be produced by execution unit(s) 124 during the execution of certain instructions (1). Cache controller 228 may respond by writing the modified data into L2 data cache 229 (2). In addition, the modified data may also be written to at least one storage location farther down in the memory hierarchy, such as a lower level cache or into main memory (3). In the case that the modified data is written to a lower level cache, the modified data is stored in at least two different locations, and is thus not exclusive to L2 data cache 229. If the modified data is written back to memory, it may cause a clearing of a corresponding dirty bit in L2 data cache 229, thereby removing the status of the data as modified.

Operation in the write-through mode is further illustrated in FIG. 8. Method 700 begins with the restoring of power (e.g., exiting a sleep state) to a cache subsystem (block 705). The method further includes the execution of instructions that may in some cases generate modified data (block 710). If modified data is generated responsive to the execution of an instruction (block 715, yes), then the cache controller may allow the modified data to be written into its corresponding cache, and may also cause the data to be written to a lower level cache or main memory (block 720). If an instruction does not generate modified data (block 715, no), then the method may proceed to block 725.

If the threshold has not been reached (block 725, no), and the processing node associated with the cache subsystem is not idle (block 730, no), the method returns to block 710. If the threshold has not been reached (block 725, no), but the processing node has become idle (block 730, yes), then the cache subsystem (and the corresponding processing node) may be placed into a sleep state by removing power (block 735). Since the threshold has not been reached in this example, it is not necessary to search the cache for modified data since the any modified data written to the cache is also stored in at least one storage location farther down in the memory hierarchy.

If the threshold is reached (block 725, yes), then processing may continue while allowing writes of modified data to the cache (block 740). The modified data may be written to and stored exclusively in the cache. The cache may maintain exclusive storage of the modified data until it is to be evicted for new data or until the cache subsystem is to be powered down. Once either of these two events occurs, the modified data may be written to a lower level cache or to main memory. At block 745, the processing node may continue operation until idle, at which time power may be removed therefrom (block 735).

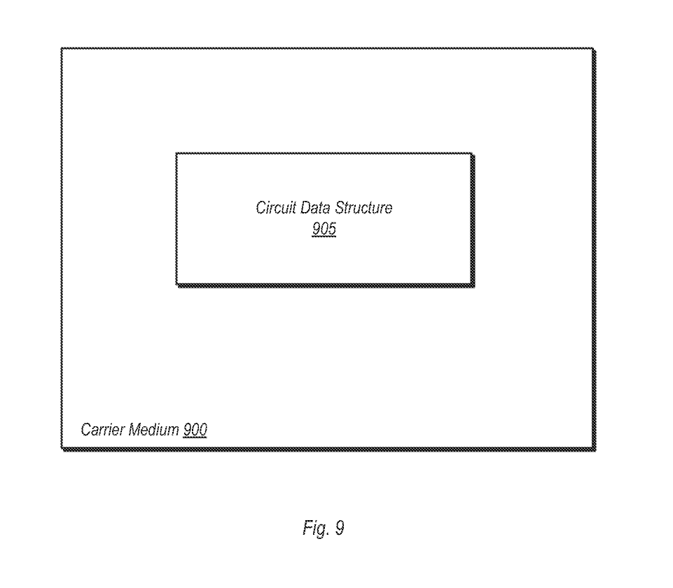

Turning next to FIG. 9, a block diagram of a computer accessible storage medium 900 including a database 905 representative of the system 10 is shown. Generally speaking, a computer accessible storage medium 900 may include any non-transitory storage media accessible by a computer during use to provide instructions and/or data to the computer. For example, a computer accessible storage medium 900 may include storage media such as magnetic or optical media, e.g., disk (fixed or removable), tape, CD-ROM, or DVD-ROM, CD-R, CD-RW, DVD-R, DVD-RW, or Blu-Ray. Storage media may further include volatile or non-volatile memory media such as RAM (e.g. synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g. Flash memory) accessible via a peripheral interface such as the Universal Serial Bus (USB) interface, etc. Storage media may include microelectromechanical systems (MEMS), as well as storage media accessible via a communication medium such as a network and/or a wireless link.

Generally, the data 905 representative of the system 10 and/or portions thereof carried on the computer accessible storage medium 900 may be a database or other data structure which can be read by a program and used, directly or indirectly, to fabricate the hardware comprising the system 10. For example, the database 905 may be a behavioral-level description or register-transfer level (RTL) description of the hardware functionality in a high level design language (HDL) such as Verilog or VHDL. The description may be read by a synthesis tool which may synthesize the description to produce a netlist comprising a list of gates from a synthesis library. The netlist comprises a set of gates which also represent the functionality of the hardware comprising the system 10. The netlist may then be placed and routed to produce a data set describing geometric shapes to be applied to masks. The masks may then be used in various semiconductor fabrication steps to produce a semiconductor circuit or circuits corresponding to the system 10. Alternatively, the database 905 on the computer accessible storage medium 900 may be the netlist (with or without the synthesis library) or the data set, as desired, or Graphic Data System (GDS) II data.

While the computer accessible storage medium 900 carries a representation of the system 10, other embodiments may carry a representation of any portion of the system 10, as desired, including IC 2, any set of agents (e.g., processing cores 11, I/O interface 13, north bridge 12, cache subsystems, etc.) or portions of agents.

While the present invention has been described with reference to particular embodiments, it will be understood that the embodiments are illustrative and that the invention scope is not so limited. Any variations, modifications, additions, and improvements to the embodiments described are possible. These variations, modifications, additions, and improvements may fall within the scope of the inventions as detailed within the following claims.

What is claimed is:

1. A cache subsystem comprising:
a cache controller for coupling to cache memory, wherein the cache controller is configured to, responsive to restoring power to the cache subsystem, inhibit writing of modified data exclusively into the cache memory.

2. The cache subsystem as recited in claim 1, wherein the cache controller is configured to cause modified data to be written to the cache memory subsequent to restoring power if the modified data is also written to at least one additional location in a memory hierarchy that is lower than the cache memory.

3. The cache subsystem as recited in claim 2, wherein the cache controller is configured to cause modified data to be written into the cache memory subsequent to restoring power if the modified data is also written to a lower level cache.

4. The cache subsystem as recited in claim 2, wherein the cache controller is configured to cause modified data to be written into the cache memory subsequent to restoring power if the modified data is also written to a main memory.

5. The cache subsystem as recited in claim 1, wherein the cache controller is configured to inhibit modified data from being written to the cache memory and further configured to cause modified data to be written to at least one additional location in a memory hierarchy that is lower than the cache memory.

6. The cache subsystem as recited in claim 5, wherein the cache controller is configured to cause modified data to be written to a lower level cache in the memory hierarchy.

7. The cache subsystem as recited in claim 5, wherein the cache controller is configured to cause modified data to be written to a main memory.

8. The cache subsystem as recited in claim 1, wherein the cache controller is configured to inhibit writing of modified data exclusively into the cache memory until a threshold value is reached, wherein the cache controller is further configured to enable modified data to be written exclusively into the cache memory subsequent to the threshold value being reached.

9. The cache subsystem as recited in claim 8, wherein the threshold is a number of events.

10. The cache subsystem as recited in claim 9, wherein the events are instances of writing modified data to at least one storage unit in a memory hierarchy.

11. The cache subsystem 8, wherein the threshold is an amount of time from which power was restored to the cache subsystem.

12. A method comprising:
restoring power to a cache subsystem; and
inhibiting modified data from being written exclusively into the cache memory responsive to restoring power to the cache subsystem.

13. The method as recited in claim 12, wherein said inhibiting is performed by a cache controller, and wherein the method further comprises:
the cache controller performing said inhibiting modified data to be written exclusively into the cache memory prior to a threshold value being reached; and
the cache controller enabling writing of modified data exclusively into the cache memory subsequent to the threshold value being reached.

14. The method as recited in claim 13, wherein the threshold value is a predetermined number of events.

15. The method as recited in claim 14, wherein the events are instances of writing modified data to at least one storage unit in a memory hierarchy.

16. The method as recited in claim 13, wherein the threshold is an amount of time from which power was restored to the cache subsystem.

17. The method as recited in claim 13, further comprising writing modified data to the cache memory and to at least one of a lower level cache memory and a main memory during a period between restoring power to the cache subsystem and reaching the threshold value.

18. The method as recited in claim 13, further comprising writing modified data into at least one additional location in a memory hierarchy lower than the cache memory while inhibiting modified data from being written into the cache memory.

19. The method as recited in claim 18, wherein the at least one additional location is in a lower level cache memory.

20. The method as recited in claim 18, wherein the at least one additional location is in a main memory.

21. The method as recited in claim 13, further comprising removing power from a processor core including the cache subsystem responsive to the processor core becoming idle prior to reaching the threshold value.

22. A system comprising:
a processor having at least one processor core, wherein the at least one processor core includes a cache subsystem, the cache subsystem including:
a first cache memory; and
a cache controller coupled to the first cache memory, wherein the first cache controller is configured to, upon restoring power to the first processor core, inhibit writing of modified data exclusively into the first cache memory.

23. The system as recited in claim 22, wherein the processor further includes a second cache memory that is lower in a memory hierarchy than the first cache memory, and wherein the system includes a main memory coupled to the processor, wherein the main memory is lower in the memory hierarchy than the second cache memory.

24. The system as recited in claim 23, wherein the cache controller is configured to enable a block of modified data to be written into the first cache memory if the block of modified data is also written to at least one of the second cache memory and the main memory.

25. The system as recited in claim 23, wherein responsive to the at least one processor core generating a block of modified data, the cache controller is configured to inhibit the block of modified data from being written to the first cache memory, and wherein the processor core is configured to cause the block of modified data to be written to at least one of the second cache memory and the main memory.

26. The system as recited in claim 22, wherein the first controller is configured to discontinue inhibiting the writing of modified data exclusively into the first cache memory if a threshold value is reached.

27. The system as recited in claim 26, further comprising a power management unit, wherein the power management unit is configured to remove power from the at least one processor core responsive to determining that the at least one processor core has become idle prior to reaching the threshold value.

28. A non-transitory computer readable medium comprising a data structure which is operated upon by a program executable on a computer system, the program operating on the data structure to perform a portion of a process to fabricate an integrated circuit including circuitry described by the data structure, the circuitry described in the data structure including:
a cache controller coupled to a cache memory, wherein the cache controller is configured to, upon restoring power to the cache subsystem, inhibit writing of modified data exclusively into the cache memory.

29. The computer readable medium as recited in claim 28, wherein the cache controller described the by the data structure is configured to discontinue inhibiting the writing of modified data exclusively into the cache memory responsive to a threshold value being reached.

30. The computer readable medium as recited in claim 28, wherein the data structure comprises one or more of the following types of data:
HDL (high-level design language) data;
RTL (register transfer level) data;
Graphic Data System (GDS) II data.
